(19) United States
(12) Patent Application Publication
(10) Pub. No.: US 2012/0281032 A1
(43) Pub. Date: Nov. 8, 2012

(54) PLASMA DISPLAY DEVICE, PLASMA DISPLAY SYSTEM AND PLASMA DISPLAY PANEL DRIVING METHOD

(76) Inventors: Yutaka Yoshihama, Osaka (JP); Yuya Shiozaki, Osaka (JP); Takahiko Origuchi, Osaka (JP)

(21) Appl. No.: 13/521,930

(22) PCT Filed: Jan. 13, 2011
(86) PCT No.: PCT/JP2011/000126

§ 371 Date: Jul. 12, 2012

(30) Foreign Application Priority Data
Jan. 14, 2010 (JP) 2010-005474

(51) Int. Cl. G09G 5/10; G09G 3/28

(52) U.S. Cl. 345/691; 345/60

(57) ABSTRACT

In a plasma display apparatus capable of displaying an image for stereoscopic view, the image display quality is enhanced. For this purpose, the plasma display apparatus includes a driver circuit and a timing generation circuit. The driver circuit drives the plasma display panel by alternately repeating a field for the right eye and a field for the left eye. The timing generation circuit generates shutter opening/closing timing signals. The driver circuit applies the sustain pulses equal in number to the luminance weight multiplied by a luminance magnification to each scan electrode and each sustain electrode, in the subfields except the first subfield. In the first subfield, the driver circuit applies the sustain pulses greater in number than the luminance weight multiplied by the luminance magnification to each scan electrode and each sustain electrode.

### TECHNICAL FIELD

The present invention relates to a plasma display apparatus, a plasma display system, and a driving method for a plasma display panel that enables the user to stereoscopically view a stereoscopic image that is made of an image for the right eye and an image for the left eye alternately displayed on the plasma display panel, using a pair of shutter glasses.

### BACKGROUND ART

An AC surface discharge panel, i.e. a typical plasma display panel (hereinafter, simply referred to as “panel”), has a front substrate and a rear substrate opposed to each other. A plurality of display electrode pairs, each including a scan electrode and a sustain electrode, is formed on the front substrate. A plurality of data electrodes is formed on the rear substrate. A large number of discharge cells are formed between the substrates. Ultraviolet rays are generated by gas discharge in the discharge cells. The ultraviolet rays excite phosphors of red color, green color, and blue color such that light is emitted for display of a color image.

A typically used driving method for the panel is a subfield method. In the subfield method, gradations are displayed by dividing one field into a plurality of subfields and causing light emission or no light emission in each discharge cell in each subfield. Each of the subfields has an initializing period, an address period, and a sustain period.

In the initializing period, an initializing operation is performed so as to cause an initializing discharge in the discharge cells, form wall charge necessary for the subsequent address operation, and generate priming particles for stably generating an address discharge (excitation particles for generating an address discharge). In the address period, an address operation is performed so as to cause an address discharge selectively in the discharge cells in response to an image to be displayed and form wall charge in the discharge cells. In the sustain period, a sustain operation is performed so as to alternately apply sustain pulses in number predetermined for each subfield to the scan electrodes and the sustain electrodes and cause a sustain discharge in the discharge cells. Then, the phosphor layers in the discharge cells having undergone the address operation are caused to emit light, and the discharge cells are lit at luminances corresponding to the gradation values of image signals. Thus, an image is displayed in the image display area of the panel.

One of the important factors in enhancing the image display quality in a panel is to enhance the contrast. One of the subfield methods discloses a driving method for enhancing the contrast ratio by minimizing the light emission unrelated to gradation display.

In this driving method, in the initializing period of one of a plurality of subfields forming one field, an initializing operation is performed so as to cause an initializing discharge in all the discharge cells. In the initializing periods of the other subfields, an initializing operation is performed so as to cause an initializing discharge selectively in the discharge cells having undergone a sustain discharge in the immediately preceding sustain period.

The luminance of a black display area where no sustain discharge occurs (hereinafter, simply referred to as “luminance of black level”) is changed by the light emission unrelated to image display. Such light emissions unrelated to image display include a light emission caused by an initializing discharge. However, in the above driving method, the light emission in the black display area is only the weak light emission caused when the initializing operation is performed in all the discharge cells. This operation allows display of an image of high contrast by reducing the luminance of black level (see Patent Literature 1, for example).

Further, application of a plasma display apparatus as a three-dimensional (hereinafter, “3D”) image display apparatus is considered.

In this plasma display apparatus, an image for the right eye and an image for the left eye that form an image for stereoscopic view (3D image) are alternately displayed on the panel. The user views the image, using a pair of special glasses, which is called shutter glasses.

The pair of shutter glasses has a shutter for the right eye and a shutter for the left eye. In the period during which an image for the right eye is displayed on the panel, the right eye shutter is opened (in a state of transmitting visible light) and the left eye shutter is closed (in a state of blocking visible light). In the period during which an image for the left eye is displayed, the left eye shutter is opened and the right eye shutter is closed. This operation enables the user to view the image for the right eye only with the right eye, and the image for the left eye only with the left eye. Thus, the user can stereoscopically view the display image.

As one of the methods for stereoscopically viewing a 3D image in a plasma display apparatus, the following method is disclosed (see Patent Literature 2, for example). A plurality of subfields is divided into a subfield group where images for the right eye are displayed and a subfield group where images for the left eye are displayed. In synchronization with the start of the address period of the first subfield in each subfield group, the shutters of a pair of shutter glasses are opened and closed.

With increases in the screen size and definition of the panel, further enhancement of the image display quality is requested. Also in the plasma display apparatus usable as a 3D image display apparatus, high image display quality is requested.

### CITATION LIST

### Patent Literature

### PTL1

Japanese Patent Unexamined Publication No. 2000-242224

### PTL2

Japanese Patent Unexamined Publication No. 2000-112428

### SUMMARY OF THE INVENTION

A plasma display apparatus of the present invention includes a panel, a driver circuit, and a timing generation circuit. The panel has a plurality of discharge cells, each of the discharge cells has a display electrode pair, and the display electrode pair includes a scan electrode and a sustain electrode. The driver circuit displays an image on the panel by alternately repeating a field for the right eye where the panel is driven based on an image signal for the right eye and a field for the left eye where the panel is driven based on an image signal for the left eye. The driver circuit drives the panel in a manner such that each of the field for the right eye and the field for the left eye is formed of a plurality of subfields, each having a sustain period where sustain pulses corresponding in number to the luminance weight are generated. The timing generation circuit generates a timing signal for controlling the driver circuit, and generates shutter opening/closing timing signals that include a timing signal for opening/closing a right eye shutter and a timing signal for opening/closing a left eye shutter. The timing signal for opening/closing the right eye shutter is set to ON when the field for the right eye is displayed on the panel and to OFF when the field for the left eye is displayed on the panel. The timing signal for opening/closing the left eye shutter is set to ON when the field for the left eye is displayed on the panel and to OFF when the field for the right eye is displayed on the panel. The driver circuit applies the sustain pulses equal in number to the luminance weight multiplied by a predetermined luminance magnification to each scan electrode and each sustain electrode, in the sustain periods of the subfields except the first subfield of one field. In the sustain period of the first subfield, the driver circuit applies the sustain pulses greater in number than the luminance weight multiplied by the predetermined luminance magnification to each scan electrode and each sustain electrode.

This configuration can change the number of sustain pulses to be generated in the sustain period of the first subfield in response to the transmittance of the pair of shutter glasses, in a plasma display apparatus usable as a 3D image display apparatus. Therefore, for instance, if the transmittance of the pair of shutter glasses in the sustain period of the first subfield is lowered by delaying the shutter opening timing of the pair of shutter glasses in order to reduce the crosstalk to the user who views a display image, the linearity of the gradations in the display image to the user who views the display image through the pair of shutter glasses can be maintained. Thus, the image display quality can be enhanced.

A plasma display system of the present invention includes a plasma display apparatus including a panel, a driver circuit, and a timing generation circuit; and a pair of shutter glasses. The panel has a plurality of discharge cells, each of the discharge cells has a display electrode pair, and the display electrode pair includes a scan electrode and a sustain electrode. The driver circuit displays an image on the panel by alternately repeating a field for the right eye where the panel is driven based on an image signal for the right eye and a field for the left eye where the panel is driven based on an image signal for the left eye. The driver circuit drives the panel in a manner such that each of the field for the right eye and the field for the left eye is formed of a plurality of subfields, each having a sustain period where sustain pulses corresponding in number to the luminance weight are generated. The timing generation circuit generates a timing signal for controlling the driver circuit, and generates shutter opening/closing timing signals that include a timing signal for opening/closing a right eye shutter and a timing signal for opening/closing a left eye shutter. The timing signal for opening/closing the right eye shutter is set to ON when the field for the right eye is displayed on the panel and to OFF when the field for the left eye is displayed on the panel. The timing signal for opening/closing the left eye shutter is set to ON when the field for the left eye is displayed on the panel and to OFF when the field for the right eye is displayed on the panel. The pair of shutter glasses is controlled by the shutter opening/closing timing signals generated in the timing generation circuit, and has the right eye shutter and the left eye shutter. The right eye shutter transmits visible light when the timing signal for opening/closing the right eye shutter is set to ON and blocks visible light when the timing signal is set to OFF. The left eye shutter transmits visible light when the timing signal for opening/closing the left eye shutter is set to ON and blocks visible light when the timing signal is set to OFF. The driver circuit applies sustain pulses equal in number to the luminance weight multiplied by a predetermined luminance magnification to each scan electrode and each sustain electrode, in the sustain periods of the subfields except the first subfield of one field. In the sustain period of the first subfield, the driver circuit applies, to each scan electrode and each sustain electrode, the sustain pulses equal in number to the luminance weight multiplied by the predetermined luminance magnification and multiplied by a factor corresponding to the transmittance of the pair of shutter glasses in the sustain period of the first subfield.

This configuration can change the number of sustain pulses in response to the transmittance of the pair of shutter glasses in the sustain period of the first subfield, in a plasma display system that includes a plasma display apparatus usable as a 3D image display apparatus. Therefore, for instance, if the transmittance of the pair of shutter glasses in the sustain period of the first subfield is lowered by delaying the shutter opening timing of the pair of shutter glasses in order to reduce the crosstalk to the user who views a display image, the linearity of the gradations in the display image to the user who views the display image through the pair of shutter glasses can be maintained. Thus, the image display quality can be enhanced.

A driving method for a panel of the present invention is a method for driving a panel that has a plurality of discharge cells, each having a display electrode pair that includes a scan electrode and a sustain electrode. An image is displayed on the panel by alternately repeating a field for the right eye where the panel is driven based on an image signal for the right eye and a field for the left eye where the panel is driven based on an image signal for the left eye. The panel is driven in a manner such that each of the field for the right eye and the field for the left eye is formed of a plurality of subfields, each having a sustain period where sustain pulses corresponding in number to the luminance weight are generated. Shutter opening/closing timing signals that include a timing signal for opening/closing a right eye shutter and a timing signal for opening/closing a left eye shutter are generated. The timing signal for opening/closing the right eye shutter is set to ON when the field for the right eye is displayed on the panel and to OFF when the field for the left eye is displayed on the panel. The timing signal for opening/closing the left eye shutter is set to ON when the field for the left eye is displayed on the panel and to OFF when the field for the right eye is displayed on the panel. In the sustain periods of the subfields except the first subfield of one field, the sustain pulses equal in number to the luminance weight multiplied by a predetermined luminance magnification are applied to each scan electrode and each sustain electrode. In the sustain period of the first subfield, the sustain pulses greater in number than the luminance weight multiplied by the predetermined luminance magnification are applied to each scan electrode and each sustain electrode.

This method can change the number of sustain pulses in response to the transmittance of the pair of shutter glasses in the sustain period of the first subfield, when an image for stereoscopic view is displayed on the panel in a plasma display apparatus usable as a 3D image display apparatus. Therefore, for instance, if the transmittance of the pair of shutter glasses in the sustain period of the first subfield is lowered by delaying the shutter opening timing of the pair of shutter glasses in order to reduce the crosstalk to the user who views a display image, the linearity of the gradations in the display image to the user who views the display image through the pair of shutter glasses can be maintained. Thus, the image display quality can be enhanced.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 shows a circuit block diagram of the plasma display apparatus and a diagram outlining a plasma display system in accordance with the exemplary embodiment.

FIG. 4 is a chart of driving voltage waveforms applied to respective electrodes of the panel for use in the plasma display apparatus in accordance with the exemplary embodiment.

FIG. 5 is a schematic diagram showing a subfield structure of the plasma display apparatus and an opening/closing operation of a pair of shutter glasses in accordance with the exemplary embodiment.

FIG. 6 is a schematic diagram showing a subfield structure of the plasma display apparatus, emission luminance in a discharge cell, and opening/closing states of a right eye shutter and a left eye shutter in accordance with the exemplary embodiment.

### DESCRIPTION OF EMBODIMENTS

Hereinafter, a plasma display apparatus in accordance with an exemplary embodiment of the present invention is described, with reference to the accompanying drawings.

### Exemplary Embodiment

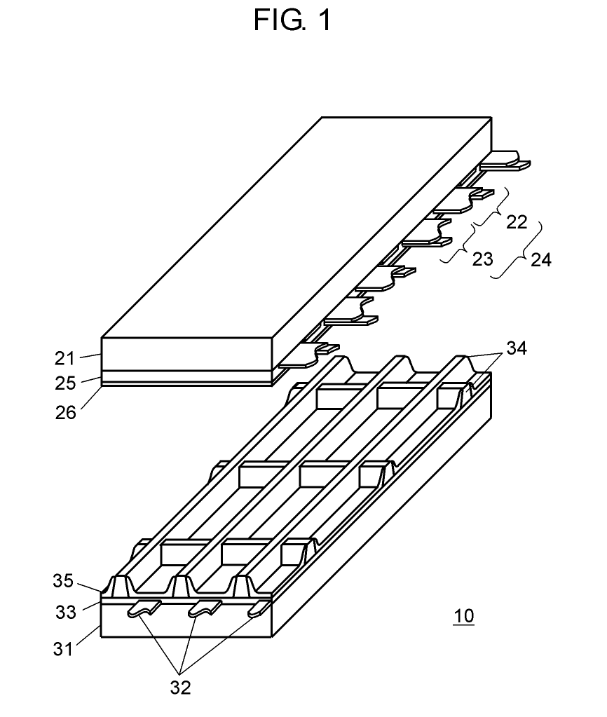

FIG. 1 is an exploded perspective view showing a structure of panel 10 for use in the plasma display apparatus in accordance with the exemplary embodiment of the present invention. A plurality of display electrode pairs 24, each including scan electrode 22 and sustain electrode 23, is disposed on glass front substrate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red color (R), green color (G), and blue color (B) are formed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a mixture gas of neon and xenon, for example, is sealed as a discharge gas. In this embodiment, a discharge gas having a xenon partial pressure of approximately 10% is used to enhance emission efficiency.

The discharge space is partitioned into a plurality of compartments by barrier ribs 34. Discharge cells are formed in the intersecting parts of display electrode pairs 24 and data electrodes 32. The discharge cells discharge and emit light (light up) so as to display a color image on panel 10.

In panel 10, three consecutive discharge cells arranged in the extending direction of display electrode pair 24, i.e. a discharge cell for emitting light of red color (R), a discharge cell for emitting light of green color (G), and a discharge cell for emitting light of blue color (B), form one pixel.

The structure of panel 10 is not limited to the above, and may include barrier ribs in a stripe pattern, for example. The mixture ratio of the discharge gas is not limited to the above numerical value, and other mixture ratios may be used.

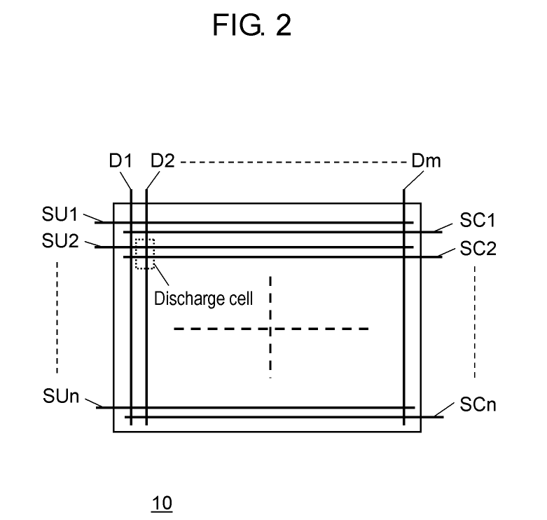

FIG. 2 is an electrode array diagram of panel 10 for use in the plasma display apparatus in accordance with the exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) both long in the row direction (line direction), and m data electrode D1-data electrode Dm (data electrodes 32 in FIG. 1) long in the column direction. A discharge cell is formed in the part where a pair of scan electrode SCi (i=1−n) and sustain electrode SUi intersects one data electrode Dj (j=1−m). That is, one display electrode pair 24 has m discharge cells, which form m/3 pixels. Then, m×n discharge cells are formed in the discharge space, and the area having m×n discharge cells is the image display area of panel 10. In a panel having 1920×1080 pixels, for example, m=1920×3 and n=1080.

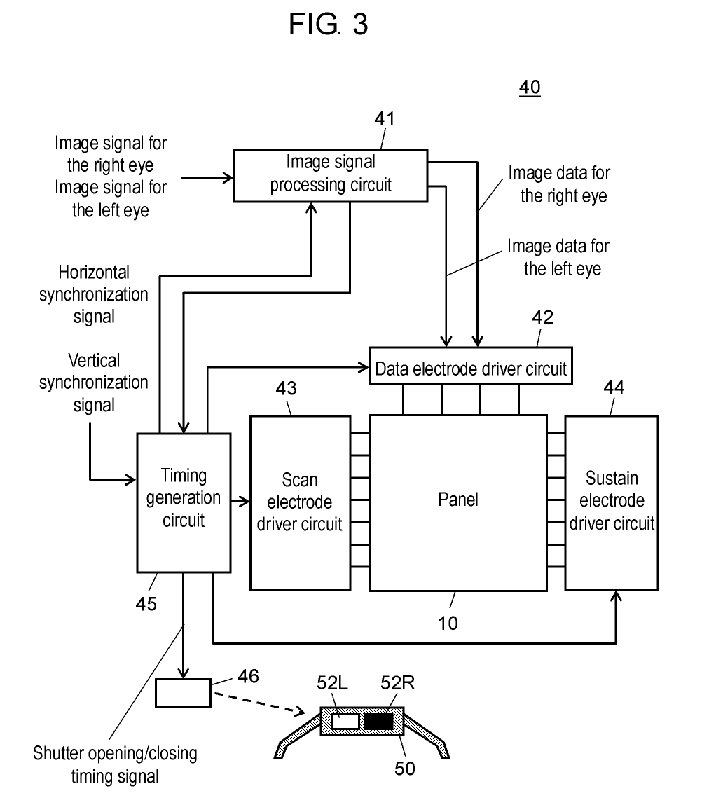

FIG. 3 shows a circuit block diagram of plasma display apparatus 40 and a diagram outlining a plasma display system in accordance with the exemplary embodiment of the present invention. The plasma display system of this exemplary embodiment includes plasma display apparatus 40 and pair of shutter glasses 50 as the elements.

Plasma display apparatus 40 includes the following elements:
panel 10 having a plurality of discharge cells arranged therein, each of the discharge cells having scan electrode 22, sustain electrode 23, and data electrode 32; and
a driver circuit for driving panel 10.
   The driver circuit includes image signal processing circuit 41; data electrode driver circuit 42; scan electrode driver circuit 43; sustain electrode driver circuit 44; timing generation circuit 45; and electric power supply circuits (not shown) for supplying electric power necessary for each circuit block. Plasma display apparatus 40 includes timing signal output part 46. Timing signal output part 46 outputs shutter opening/closing timing signals for controlling the opening/closing of the shutters of pair of shutter glasses 50 used by the user.

Image signal processing circuit 41 allocates gradation values to each discharge cell, based on an input image signal. The image signal processing circuit converts the gradation values into image data representing light emission and no light emission in each subfield. For instance, when input image signal sig includes an R signal, a G signal, and a B signal, R, G, and B gradation values are allocated to the respective discharge cells, based on the R signal, G signal, and B signal. When input image signal sig includes a luminance signal (Y signal) and a chroma signal (C signal, R-Y signal and B-Y signal, u signal and v signal, or the like), the R signal, G signal, and B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield. When the input image signal is a 3D image signal that includes an image signal for the right eye and an image signal for the left eye and the 3D image signal is displayed on panel 10, the image signal for the right eye and the image signal for the left eye are alternately input to image signal processing circuit 41 in each field. Thus, image signal processing circuit 41 converts the image signal for the right eye into image data for the right eye, and the image signal for the left eye into image data for the left eye.

Data electrode driver circuit 42 converts the image data for the right eye and the image data for the left eye into signals (address pulses) corresponding to each of data electrode D1-data electrode Dm, and applies the signals to corresponding data electrode D1-data electrode Dm.

Timing generation circuit 45 generates various timing signals for controlling the operation of each circuit block, based on a horizontal synchronization signal and a vertical synchronization signal. Then, the timing generation circuit supplies the generated timing signals to respective circuit blocks (e.g. image signal processing circuit 41, data electrode driver circuit 42, scan electrode driver circuit 43, and sustain electrode driver circuit 44). Timing generation circuit 45 also outputs shutter opening/closing timing signals for controlling the opening/closing of the shutters of pair of shutter glasses 50, to timing signal output part 46. Timing generation circuit 45 sets a shutter opening/closing timing signal to ON (“1”) when a shutter of pair of shutter glasses 50 is opened (in a state of transmitting visible light). The timing generation circuit sets the shutter opening/closing timing signal to OFF (“0”) when the shutter of pair of shutter glasses 50 is closed (in a state of blocking visible light). The shutter opening/closing timing signals include two types of timing signals: a timing signal (timing signal for opening/closing the right eye shutter) that is set to ON when a field for the right eye for display of an image signal for the right eye is displayed on panel 10, and is set to OFF when a field for the left eye for display of an image signal for the left eye is displayed on panel 10; and a timing signal (timing signal for opening/closing the left eye shutter) that is set to ON when a field for the left eye for display of an image signal for the left eye is displayed on panel 10, and is set to OFF when a field for the right eye for display of an image signal for the right eye is displayed on panel 10.

Timing signal output part 46 includes a light-emitting element, such as a light emitting diode (LED), and supplies shutter opening/closing timing signals to pair of shutter glasses 50 as those converted into infrared signals, for example.

Scan electrode driver circuit 43 has an initializing waveform generation circuit, a sustain pulse generation circuit, and a scan pulse generation circuit (not shown). The initializing waveform generation circuit generates an initializing waveform to be applied to scan electrode SC1-scan electrode SCn in the initializing periods. The sustain pulse generation circuit generates a sustain pulse to be applied to scan electrode SC1-scan electrode SCn in the sustain periods. The scan pulse generation circuit has a plurality of scan electrode driver ICs (scan ICs), and generates a scan pulse to be applied to scan electrode SC1-scan electrode SCn in the address periods. Scan electrode driver circuit 43 drives each of scan electrode SC1-scan electrode SCn in response to the timing signals supplied from timing generation circuit 45.

Sustain electrode driver circuit 44 has a sustain pulse generation circuit and a circuit for generating voltage Ve1 and voltage Ve2 (not shown), and drives sustain electrode SU1-sustain electrode SUn in response to the timing signals supplied from timing generation circuit 45.

Pair of shutter glasses 50 has right eye shutter 52R and left eye shutter 52L. Right eye shutter 52R and left eye shutter 52L can be opened and closed independently. In pair of shutter glasses 50, right eye shutter 52R and left eye shutter 52L are opened and closed in response to shutter opening/closing timing signals that are supplied from timing signal output part 46. Right eye shutter 52R opens (transmits visible light) when the timing signal for opening/closing the right eye shutter is set to ON, and closes (blocks visible light) when the timing signal for opening/closing the right eye shutter is set to OFF. Left eye shutter 52L opens (transmits visible light) when the timing signal for opening/closing the left eye shutter is set to ON, and closes (blocks visible light) when the timing signal for opening/closing the left eye shutter is set to OFF. Right eye shutter 52R and left eye shutter 52L can be formed of liquid crystal, for example. However, in the present invention, the material making up the shutters is not limited to liquid crystal. As long as blocking and transmission of visible light can be switched at a high speed, any material may be used.

Next, driving voltage waveforms for driving panel 10 and the operation thereof are outlined. Plasma display apparatus 40 of this exemplary embodiment display gradations by a subfield method. In the subfield method, one field is divided into a plurality of subfields along a temporal axis, and a luminance weight is set for each subfield. Then, by controlling the light emission and no light emission in each discharge cell in each subfield, an image is displayed on panel 10.

In this exemplary embodiment, image signals input to plasma display apparatus 40 are 3D image signals, i.e. image signals for stereoscopic view that are made of an image signal for the right eye and an image signal for the left eye alternately repeated in each field. Then, a field for the right eye for display of an image signal for the right eye and a field for the left eye for display of an image signal for the left eye are alternately repeated. Thereby, an image for stereoscopic view (3D image) made of the image for the right eye and the image for the left eye is displayed on panel 10.

Thus, the number of 3D images displayed per unit time (e.g. 1 sec) is a half the field frequency (the number of fields generated per second). For instance, when the field frequency is 60 Hz, 30 images for the right eye and 30 images for the left eye are displayed per second. Thus, thirty 3D images are displayed per second. Then, in this exemplary embodiment, the field frequency is set to twice (e.g. 120 Hz) the general field frequency such that flickering (flickers) likely to occur in display of 3D images is reduced.

The user perceives 3D images displayed on panel 10 through pair of shutter glasses 50 where right eye shutter 52R and left eye shutter 52L are opened and closed in synchronization with the field for the right eye and the field for the left eye, respectively. With this operation, the user can view an image for the right eye only with the right eye and an image for the left eye only with the left eye, thereby stereoscopically viewing the 3D image displayed on panel 10.

In the field for the right eye and the field for the left eye, only the signals of the images to be displayed are different. The subfield structure, e.g. the number of subfields forming one field, the luminance weights of the respective subfields, and the arrangement of the subfields, is identical. Hereinafter, when a field “for the right eye” and a field “for the left eye” do not need to be discriminated, each of the field for the right eye and the field for the left eye is simply referred to as a field, and each of an image signal for the right eye and an image signal for the left eye is also simply referred to as an image signal. The structure of a field is also referred to as the subfield structure.

First, a description is provided for the structure of one field and the driving voltage waveforms applied to the respective electrodes. Each field has a plurality of subfields, and each subfield has an initializing period, an address period, and a sustain period.

In the initializing period, an initializing discharge is caused so as to form wall charge necessary for the subsequent address discharge on the respective electrodes. The initializing operation at this time includes an all-cell initializing operation and a selective initializing operation. The all-cell initializing operation causes initializing discharge in all the discharge cells regardless of whether a discharge has occurred or not. The selective initializing operation causes an initializing discharge selectively in the discharge cells having undergone an address discharge in the address period of the immediately preceding subfield. Hereinafter, the initializing period where an all-cell initializing operation is performed is referred to as “all-cell initializing period”, and the subfield including the all-cell initializing period is referred to as “all-cell initializing subfield”. The initializing period where a selective initializing operation is performed is referred to as “selective initializing period”, and the subfield including the selective initializing period is referred to as “selective initializing subfield”.

In the address period, an address pulse is applied selectively to data electrodes 32 so as to cause an address discharge and form wall charge in the discharge cells to be lit. In the sustain period, sustain pulses corresponding in number to the luminance weight predetermined for each subfield are alternately applied to display electrode pairs 24 so as to cause a sustain discharge and emit light in the discharge cells having undergone the address discharge.

In this exemplary embodiment, in one field, the first subfield is a subfield having the smallest luminance weight, the succeeding subfield is a subfield having the largest luminance weight, and the subfields thereafter have the luminance weights sequentially decreasing. In this exemplary embodiment, the following description is provided for the following structure as a specific example. Each of the field for the right eye and the field for the left eye is formed of five subfields (subfield SF1, subfield SF2, subfield SF3, subfield SF4, and subfield SF5). Respective subfields have luminance weights of 1, 16, 8, 4, and 2. In this exemplary embodiment, this structure of the respective fields can reduce the leak of the light emission from an image for the right eye into an image for the left eye, and the leak of the light emission from an image for the left eye into an image for the right eye (hereinafter referred to as “crosstalk”), and stabilize the address operation. This will be detailed later.

In this exemplary embodiment, a description is provided for an example where the first subfield (the subfield occurring first) of each of the field for the right eye and the field for the left eye is the all-cell initializing subfield. That is, in the initializing period of subfield SF1, an all-cell initializing operation is performed. In the initializing periods of the other subfields (subfield SF2-subfield SF5), a selective initializing operation is performed. This structure can cause an initializing discharge in all the discharge cells at least once in one field, thus stabilizing the address operation. Further, the light emission unrelated to image display is only the light emission caused by the discharge in the all-cell initializing operation in subfield SF1. Thus, luminance of black level, i.e. the luminance of a black display area where no sustain discharge occurs, is reduced, and an image of high contrast can be displayed on panel 10.

In the sustain period of each subfield, sustain pulses corresponding in number to the luminance weight predetermined for each subfield are alternately applied to display electrode pairs 24. Thus, a sustain discharge is caused and light is emitted in the discharge cells having undergone the address discharge.

In this exemplary embodiment, as described above, in each of fields for the right eye and fields for the left eye, the luminance weights of the subfields are set as follows. Subfield SF1, which occurs first, is the subfield having the smallest luminance weight (e.g. luminance weight “1”). Subfield SF2, which occurs second, is the subfield having the largest luminance weight (e.g. luminance weight “16”). The subfields thereafter (e.g. subfield SF3-subfield SF5) have the luminance weights sequentially decreasing.

The luminance weight represents a ratio of the magnitudes of luminance displayed in the respective subfields. In the sustain period of each subfield, sustain pulses corresponding in number to the luminance weight are generated. For example, in the sustain period of a subfield having the luminance weight “8”, a number of sustain pulses that is four times the number of sustain pulses in the subfield having the luminance weight “2” are generated, and a number of sustain pulses that is twice the number of sustain pulses in the subfield having the luminance weight “4” are generated. Thus, the luminance of the light emission in the subfield having the luminance weight “8” is approximately four times as high as that in the subfield having the luminance weight “2”, and approximately twice as high as that in the subfield having the luminance weight “4”. Therefore, the selective light emission caused by the combination of the respective subfields in response to image signals allows display of various gradations and an image.

In the sustain period of each subfield, a number of sustain pulses based on the luminance weight of the corresponding subfield multiplied by a predetermined proportionality factor are applied to respective display electrode pairs 24. This proportionality factor is a luminance magnification.

In this exemplary embodiment, when the luminance magnification is 1, four sustain pulses are generated in the sustain period of a subfield having the luminance weight “2”, and two sustain pulses are applied to each of scan electrodes 22 and sustain electrodes 23. That is, in each sustain period, sustain pulses equal in number to the luminance weight of the corresponding subfield multiplied by a predetermined luminance magnification are applied to each of scan electrodes 22 and sustain electrodes 23. Therefore, when the luminance magnification is 2, the number of sustain pulses generated in the sustain period of a subfield having the luminance weight “2” is 8. When the luminance magnification is 3, the number of sustain pulses generated in the sustain period of a subfield having the luminance weight “2” is 12.

However, in this exemplary embodiment, the number of subfields forming one field, or the luminance weights of the respective subfields is not limited to the above values. Alternatively, the subfield structure may be switched in response to an image signal, for example.

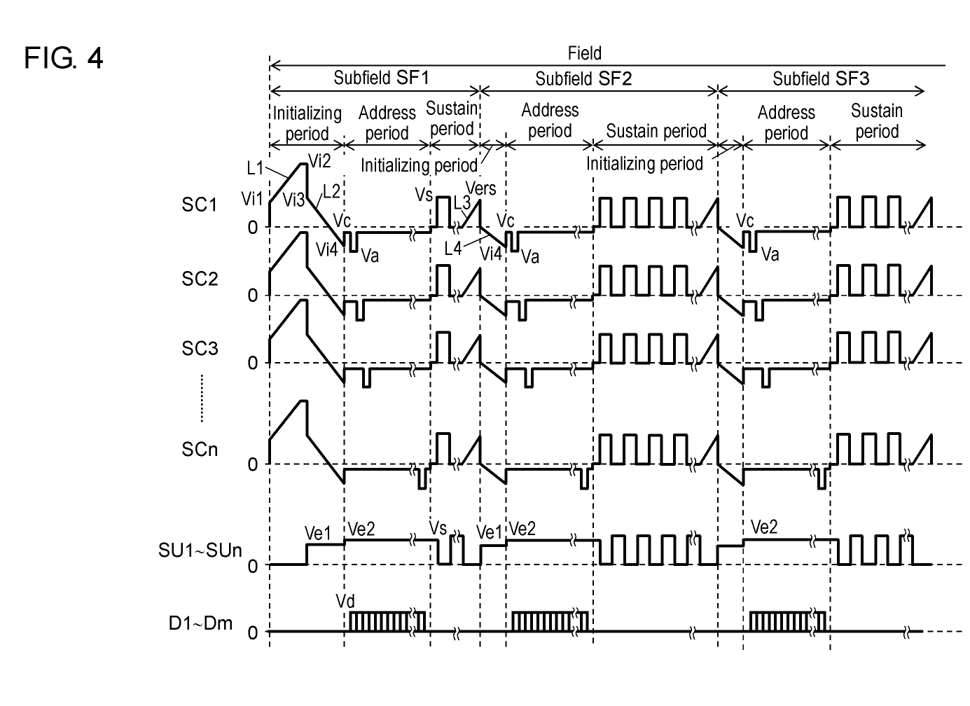

FIG. 4 is a chart of driving voltage waveforms applied to the respective electrodes of panel 10 for use in plasma display apparatus 40 in accordance with the exemplary embodiment of the present invention. FIG. 4 shows driving voltage waveforms applied to the following electrodes: scan electrodes 22 from scan electrode SC1 for undergoing an address operation first in the address periods to scan electrode SC3; scan electrode SCn for undergoing an address operation last in the address periods; sustain electrode SU1-sustain electrode SUn; and data electrodeD1-data electrode Dm.

The following description is provided for the driving voltage waveforms in two subfields: subfield SF1, i.e. an all-cell initializing subfield; and subfield SF2, i.e. a selective initializing subfield. The driving voltage waveforms in the other subfields are substantially similar to those in subfield SF2 except for the numbers of sustain pulses in the sustain periods. Scan electrode SCi, sustain electrode SUi, and data electrode Dk in the following description are the electrodes selected from the respective electrodes, based on image data (data representing the light emission and no light emission in each subfield).

First, a description is provided for subfield SF1, i.e. an all-cell initializing subfield having the smallest luminance weight.

In the first half of the initializing period (all-cell initializing period) of subfield SF1, voltage 0 (V) is applied to each of data electrode D1-data electrode Dm and sustain electrode SU1-sustain electrode SUn. Voltage Vi1 is applied to scan electrode SC1-scan electrode SCn. Voltage Vi1 is set to a voltage lower than a discharge start voltage with respect to sustain electrode SU1-sustain electrode SUn. Further, a ramp waveform voltage gently rising from voltage Vi1 toward voltageVi2 (with a gradient of approximately 1.3 V/μsec, for example) is applied to scan electrode SC1-scan electrode SCn (hereinafter, the ramp waveform voltage being referred to as “up-ramp voltage L1”). Voltage Vi2 is set to a voltage exceeding the discharge start voltage with respect to sustain electrode SU1-sustain electrode SUn.

While up-ramp voltage L1 is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn, and positive wall voltage accumulates on data electrode D1-data electrode Dm and sustain electrode SU1-sustain electrode SUn. This wall voltage on the electrodes means voltages that are generated by the wall charge accumulated on the dielectric layers covering the electrodes, the protective layer, the phosphor layers, or the like.

In the second half of the initializing period (all-cell initializing period), positive voltageVe1 is applied to sustain electrode SU1-sustain electrode SUn, and voltage 0 (V) is applied to data electrode D1-data electrode Dm. A ramp waveform voltage gently falling from voltage Vi3 toward negative voltageVi4 (with a gradient of approximately −2.5 V/μsec, for example) is applied to scan electrode SC1-scan electrode SCn (hereinafter, the ramp waveform voltage being referred to as “down-ramp voltage L2”). Voltage Vi3 is set to a voltage lower than the discharge start voltage with respect to sustain electrode SU1-sustain electrode SUn, and voltage Vi4 is set to a voltage exceeding the discharge start voltage.

While down-ramp voltage L2 is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrodeD1-data electrode Dm. This weak discharge reduces the negative wall voltage on scan electrode SC1-scan electrode SCn and the positive wall voltage on sustain electrode SU1-sustain electrode SUn, and adjusts the positive wall voltage on data electrode D1-data electrode Dm to a value appropriate for the address operation. In this manner, the all-cell initializing operation for forcedly causing an initializing discharge in all the discharge cells is completed.

In the address period of subfield SF1, a scan pulse at voltage Va is sequentially applied to scan electrode SC1-scan electrode SCn. An address pulse at positive voltage Vd is applied to data electrode Dk (k=1−m) corresponding to a discharge cell to be lit among data electrode D1-data electrode Dm. Thus, an address discharge is selectively caused in the respective discharge cells.

Specifically, first, voltage Ve2 is applied to sustain electrode SU1-sustain electrode SUn, and voltage Vc (where voltage Vc=voltage Va+voltage Vsc) is applied to scan electrode SC1-scan electrode SCn.

Next, a scan pulse at negative voltage Va is applied to scan electrode SC1 in the first line. Further, in response to an image signal, an address pulse at positive voltage Vd is applied to data electrode Dk of a discharge cell to be lit in the first line among data electrode D1-data electrode Dm. Thus, the voltage difference in the intersecting part of data electrode Dk and scan electrode SC1 in the discharge cell applied with the address pulse is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltageVe2−voltageVa). At this time, setting voltage Ve2 to a voltage value slightly lower than the discharge start voltage can make the state where a discharge is likely to occur but does not actually occurs between sustain electrode SU1 and scan electrode SC1.

With this setting, a discharge occurring between data electrode Dk and scan electrode SC1 can trigger a discharge between the areas of sustain electrode SU1 and scan electrode SC1 intersecting data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, address operation is performed so as to cause an address discharge in the discharge cells to be lit in the first line and accumulate wall voltage on the respective electrodes. In contrast, the voltage in the intersecting parts of scan electrode SC1 and data electrodes 32 applied with no address pulse does not exceed the discharge start voltage, and thus no address discharge occurs.

Next, a scan pulse is applied to scan electrode SC2 in the second line, and an address pulse is applied to data electrode Dk in a discharge cell to be lit in the second line, based on an image signal. This operation causes an address discharge in the discharge cells to be lit in the second line.

Thereafter, a scan pulse is sequentially applied to scan electrode SC3-scan electrode SCn until the address operation similar to the above reaches the discharge cells in the n-th line. Thus, the address period is completed.

In the subsequent sustain period, sustain pulses are alternately applied to display electrode pairs 24. This application causes a sustain discharge in the discharge cells having undergone the address discharge, and the discharge cells emit light.

In this sustain period, first, a sustain pulse at positive voltage Vs is applied to scan electrode SC1-scan electrode SCn, and a ground electric potential as a base electric potential, i.e. voltage 0 (V), is applied to sustain electrode SU1-sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0 (V) as the base electric potential is applied to scan electrode SC1-scan electrode SCn, and a sustain pulse at voltage Vs is applied to sustain electrode SU1-sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses are alternately applied to scan electrode SC1-scan electrode SCn and sustain electrode SU1-sustain electrode SUn. Thereby, the sustain discharge is continued in the discharge cells having undergone the address discharge in the address period.

The number of sustain pulses generated in each sustain period is based on the luminance weight of the corresponding subfield multiplied by a predetermined luminance magnification. Sustain pulses equal in number to the luminance weight multiplied by the luminance magnification are applied to each of scan electrodes 22 and sustain electrodes 23. However, in this exemplary embodiment, in the sustain period of subfield SF1, the sustain pulses greater in number than the luminance weight multiplied by the luminance magnification are applied to each of scan electrodes 22 and sustain electrodes 23. The reason for this application will be described later.

After the sustain pulses have been generated in the sustain period, a ramp waveform voltage (referred to as “erasing ramp voltage L3”) gently rising from voltage 0 (V) toward voltage Vers (with a gradient of approximately 10 V/μsec, for example) is applied to scan electrode SC1-scan electrode SCn while voltage 0 (V) is applied to sustain electrode SU1-sustain electrode SUn and data electrode D1-data electrode Dm. Voltage Vers set to a voltage exceeding the discharge start voltage causes a weak discharge between sustain electrode SUi and scan electrode SCi in the discharge cell having undergone a sustain discharge. The charged particles generated by this weak discharge accumulate on sustain electrode SUi and scan electrode SCi so as to reduce the voltage difference between sustain electrode SUi and scan electrode SCi. Thereby, in the discharge cell having undergone the sustain discharge, a part or the whole of the wall voltage on scan electrode SCi and sustain electrode SUi is erased while the positive wall charge is left on data electrode Dk.

After the rising voltage has reached voltage Vers, the voltage applied to scan electrode SC1-scan electrode SCn is lowered to voltage 0 (V). Thus, the sustain operation in the sustain period is completed.

Next, a description is provided for subfield SF2, i.e. a selective initializing subfield having the largest luminance weight.

In the initializing period (selective initializing period) of subfield SF2, voltage Ve1 is applied to sustain electrode SU1-sustain electrode SUn, and voltage 0 (V) is applied to data electrode D1-data electrode Dm. A ramp waveform voltage (down ramp voltage L4), which gently falls from a voltage (e.g. voltage 0 (V)) lower than the discharge start voltage toward negative voltage Vi4 exceeding the discharge start voltage (with a gradient equal to that of down ramp voltage L2, for example), is applied to scan electrode SC1-scan electrode SCn.

This voltage application causes a weak initializing discharge in the discharge cells having undergone a sustain discharge in the sustain period of the immediately preceding subfield (subfield SF1 in FIG. 4). This weak discharge reduces the wall voltage on scan electrode SCi and sustain electrode SUi. Since sufficient positive wall voltage is accumulated on data electrode Dk by the immediately preceding sustain discharge, the excess part of this wall voltage is discharged and the wall voltage is adjusted to a value appropriate for the address operation.

In contrast, in the discharge cells having undergone no sustain discharge in the sustain period of the immediately preceding subfield, no initializing discharge occurs, and the wall charge at the completion of the initializing period of the immediately preceding subfield is maintained. In this manner, the initializing operation in the initializing period (selective initializing period) of subfield SF2 is a selective initializing operation for causing an initializing discharge in the discharge cells having undergone an address operation in the address period of the immediately preceding subfield, i.e. in the discharge cells having undergone a sustain discharge in the sustain period of the immediately preceding subfield.

The operation in the subsequent address period is the same as the operation in the address period of subfield SF1. The operation in the subsequent sustain period is also the same as the operation in the sustain period of subfield SF1 except for the number of sustain pulses.

The operations in subfield SF3 and thereafter are the same as those in subfield SF2 except for the numbers of sustain pulses in the sustain periods.

The above description has outlined the driving voltage waveforms applied to the respective electrodes of panel 10 in this exemplary embodiment.

The voltage to be applied to the respective electrodes in this exemplary embodiment includes the following values: voltage Vi1=145 (V); voltage Vi2=335 (V); voltage Vi3=190 (V); voltage Vi4=−160 (V); voltage Va=−180 (V); voltage Vc=−35 (V); voltage Vs=190 (V); voltage Vers=190 (V); voltage Ve1=125 (V); voltage Ve2=130 (V); and voltage Vd=60 (V). However, these voltage values are only examples. Preferably, each of the voltage values is set appropriately for the characteristics of panel 10, the specifications of plasma display apparatus 40, or the like. For example, voltage Ve1 and voltage Vet may be equal, and voltage Vc may be at a positive value.

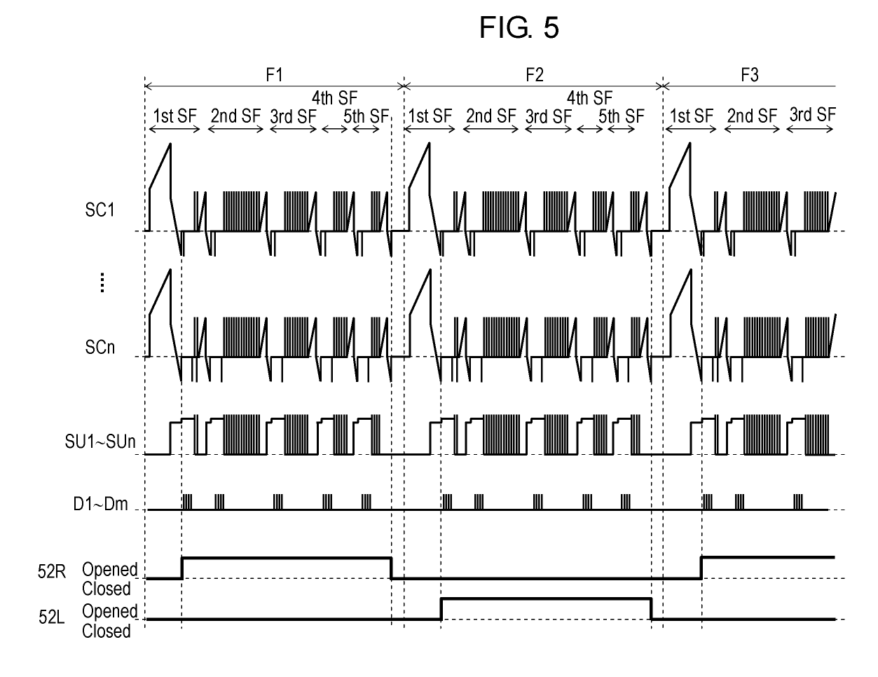

Next, the subfield structure in plasma display apparatus 40 of this exemplary embodiment is described again. FIG. 5 is a schematic diagram showing a subfield structure of plasma display apparatus 40 and an opening/closing operation of pair of shutter glasses 50 in accordance with the exemplary embodiment of the present invention. FIG. 5 shows driving voltage waveforms applied to scan electrode SC1 for undergoing an address operation first in the address periods, scan electrode SCn for undergoing an address operation last in the address periods, sustain electrode SU1-sustain electrode SUn, and data electrodeD1-data electrode Dm, together with an opening/closing operation of right eye shutter 52R and left eye shutter 52L. FIG. 5 also shows three fields (field F1-field F3).

In this exemplary embodiment, in order to display a 3D image on panel 10, a field for the right eye and a field for the left eye are alternately generated. For example, among three fields shown in FIG. 5, field F1 and field F3 are fields for the right eye where image signals for the right eye are displayed on panel 10, and field F2 is a field for the left eye where an image signal for the left eye is displayed on panel 10.

The user who views a 3D image displayed on panel 10 through pair of shutter glasses 50 perceives images displayed in two fields (an image for the right eye and an image for the left eye) as one 3D image. Thus, the user perceives the number of images displayed on panel 10 per second as a half the number of fields displayed per second. For instance, when the field frequency of 3D images displayed on the panel (the number of fields generated per second) is 60 Hz, the user perceives thirty 3D images per second. Therefore, in order to display sixty 3D images per second, the field frequency needs to be set to 120 Hz, which is twice of 60 Hz. Then, in this exemplary embodiment, the field frequency (the number of fields generated per second) is set to twice (e.g. 120 Hz) the general field frequency so that the user can perceive smooth 3D moving images.

The opening/closing operation of right eye shutter 52R and left eye shutter 52L of pair of shutter glasses 50 is controlled in response to ON/OFF of the shutter opening/closing timing signals output from timing signal output part 46. Timing generation circuit 45 generates shutter opening/closing timing signals such that both timing signals are set to OFF (such that both of a timing signal for opening/closing the right eye shutter and a timing signal for opening/closing the left eye shutter are set to OFF) in the all-cell initializing period of a field for the right eye and in the all-cell initializing period of a field for the left eye.

That is, timing generation circuit 45 generates shutter opening/closing timing signals such that both of right eye shutter 52R and left eye shutter 52L of pair of shutter glasses 50 close (block visible light) in the all-cell initializing periods of fields for the right eye and in the all-cell initializing periods of fields for the left eye. That is, in the fields for the right eye (e.g. field F1 and field F3), a shutter opening/closing timing signal (timing signal for opening/closing the right eye shutter) is generated such that right eye shutter 52R opens before the start of the sustain period of subfield SF1, i.e. the first subfield, and right eye shutter 52R closes after the generation of sustain pulses in the sustain period of subfield SF5, i.e. the last subfield, has been completed. In the field for the left eye (e.g. field F2), a shutter opening/closing timing signal (timing signal for opening/closing the left eye shutter) is generated such that left eye shutter 52L opens before the start of the sustain period of subfield SF1, and left eye shutter 52L closes after the generation of sustain pulses in the sustain period of subfield SF5 has been completed.

Therefore, shutter opening/closing timing signals (a timing signal for opening/closing the right eye shutter and a timing signal for opening/closing the left eye shutter) are generated in the following manner. In the period during which right eye shutter 52R is opened, left eye shutter 52L is closed, and in the period during which left eye shutter 52L is opened, right eye shutter 52L is closed. Further, at least in the initializing period of subfield SF1, both of right eye shutter 52R and left eye shutter 52L are closed. The similar operation is repeated in the respective fields.

With this operation, in this exemplary embodiment, both of right eye shutter 52R and left eye shutter 52L of pair of shutter glasses 50 are in a closed state in the initializing period (all-cell initializing period) of the all-cell initializing subfield (SF1) of any of the fields for the right eye and the fields for the left eye. That is, the light emission generated by the all-cell initializing operation is blocked by right eye shutter 52R and left eye shutter 52L and does not enter the eyes of the user. In this state, the user who views a 3D image through pair of shutter glasses 50 does not perceive the light emission caused by the all-cell initializing operation. This phenomenon reduces the luminance of black level by the luminance caused by that light emission. In this manner, in this exemplary embodiment, the user can perceive an image of high contrast at reduced luminance of black level.

In this exemplary embodiment, the above state where “shutters are closed” is not limited to the state where right eye shutter 52R and left eye shutter 52L are completely closed. Similarly, the above state where “shutters are opened” is not limited to the state where right eye shutter 52R and left eye shutter 52L are completely opened. Next, a detailed description is provided for the afterglow in each subfield and the opening/closing operations of the shutters of pair of shutter glasses 50.

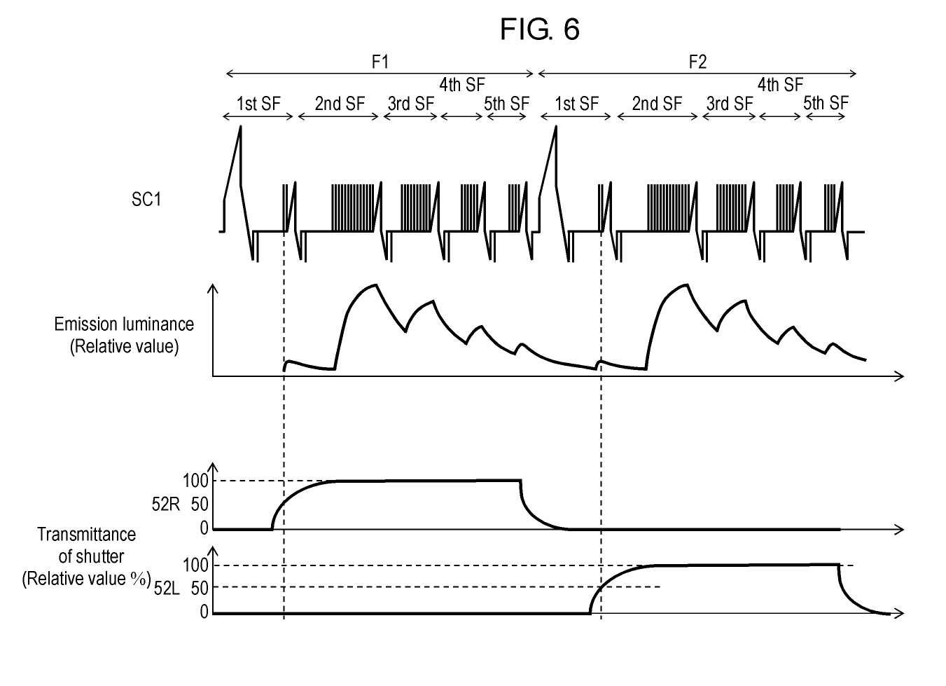

FIG. 6 is a schematic diagram showing a subfield structure of plasma display apparatus 40, emission luminance in a discharge cell, and opening/closing states of right eye shutter 52R and left eye shutter 52L in accordance with the exemplary embodiment of the present invention. FIG. 6 shows driving voltage waveforms to be applied to scan electrode SC1, a waveform showing an emission luminance (a relative value), and opening/closing states of right eye shutter 52R and left eye shutter 52L of pair of shutter glasses 50. FIG. 6 shows two fields (field for the right eye F1 and field for the left eye F2).

In the diagram of emission luminance in FIG. 6, the emission luminance is shown in a relative manner. The value in a higher position along the vertical axis shows a greater value, i.e. a higher emission luminance. In the diagram of the opening/closing states of the shutter, the opening/closing states of right eye shutter 52R and left eye shutter 52L are shown with a transmittance. Along the vertical axis, the transmittance of the shutter is relatively shown with a transmittance of the shutter in the completely opened state (the maximum transmittance) as 100% and a transmittance of the shutter in the completely closed state (the minimum transmittance) as 0%. In each waveform chart of FIG. 6, the horizontal axis shows time.

As described above, in this exemplary embodiment, in one field, the first subfield is a subfield having the smallest luminance weight, the succeeding subfield is a subfield having the largest luminance weight, and the subfields thereafter have the luminance weights sequentially decreasing. In the example shown in FIG. 6, each of the field for the right eye and the field for the left eye is formed of five subfields (subfield SF1, subfield SF2, subfield SF3, subfield SF4, and subfield SF5), and the respective subfields have luminance weights of 1, 16, 8, 4, and 2. The reason why each field has such a subfield structure in this exemplary embodiment is as follows.

Phosphor layers 35 for use in panel 10 have afterglow characteristics depending on the materials making up the phosphors. This afterglow is a phenomenon such that the phosphor maintains light emission even after the completion of discharge. When the phosphor emits light at higher luminance, the afterglow is stronger. The afterglow has a time constant corresponding to the characteristic of the phosphor. In response to the time constant, the emission luminance gradually attenuates with a lapse of time. For example, there is a phosphor material that has a characteristic of persistence of afterglow for several microseconds after the completion of a sustain discharge. When the phosphor emits light at a higher luminance, the time taken for attenuation is longer.

The light emission in a subfield having a larger luminance weight causes an emission luminance higher than that of the light emission in a subfield having a smaller luminance weight. Therefore, the afterglow caused by the light emission in a subfield having a larger luminance weight has a higher luminance and takes a longer attenuation time than the afterglow caused by the light emission in a subfield having a smaller luminance weight.

For this reason, if the last subfield of one field is a subfield having a large luminance weight, the afterglow leaking into the succeeding field is larger than that when the last subfield is a subfield having a small luminance weight. In plasma display apparatus 40 for displaying a 3D image on panel 10 by alternately generating a field for the right eye and a field for the left eye, when the afterglow generated in one field leaks into the succeeding field, the afterglow is perceived by the user as unnecessary light emission unrelated to an image signal. This phenomenon is crosstalk.

For instance, if an image for the left eye is displayed on panel 10 after the field for display of an image for the right eye has been completed and before the persistence of vision caused by the afterglow of the image for the right eye disappears, crosstalk, i.e. the entry of the image for the right eye into the image for the left eye, occurs. As the luminance of the afterglow and thus the crosstalk increase, the stereoscopic view of a 3D image is inhibited. As a result, the image display quality in plasma display apparatus 40 is degraded. This image display quality is the image display quality for the user who views a 3D image through pair of shutter glasses 50.

The following method is preferable in reducing crosstalk. A subfield having a large luminance weight is generated at an earlier time of one field so as to allow the strong afterglow to settle in that field. Further, the luminance weight is sequentially decreased in the order of the subfields and the last subfield of the one field is set to a subfield having a small luminance weight such that the afterglow is sequentially reduced in the order of the subfields and the leak of the afterglow into the next field is minimized.

On the other hand, in this exemplary embodiment, in order to reduce the luminance of black level and stabilize the address discharge, subfield SF1 is set to an all-cell initializing subfield and the other subfields to selective initializing subfields. Therefore, in the initializing period of subfield SF1, an initializing discharge can be caused in all the discharge cells so as to generate wall charge and priming particles necessary for the address operation. However, these wall charge and priming particles are gradually lost with a lapse of time.

For instance, the wall charge and priming particles in the last subfield (e.g. subfield SF5) of one field are compared between a discharge cell for undergoing address operation in intermediate subfields (e.g. any one or a plurality of subfield SF1-subfield SF4) and a discharge cell for undergoing no address operation in the intermediate subfields. In this case, the wall charge and priming particles are less in the discharge cell for undergoing no address operation in the intermediate subfields.

In the discharge cell for undergoing address operation in the intermediate subfields, a sustain discharge is caused by the address operation, which generates wall charge and priming particles. In contrast, in the discharge cell for undergoing no address operation in the intermediate subfields, no sustain discharge occurs after the initializing operation in subfield SF1 until the time immediately before the last subfield. Thus, there is no opportunity to generate wall charge and priming particles. As a result, the wall charge and priming particles in the discharge cell reduce more. This phenomenon can destabilize the address operation in the last subfield.

In the subfield having the largest luminance weight, a sustain discharge occurs in discharge cells displaying bright gradations but no sustain discharge occurs in discharge cells displaying dark gradations. For instance, when an image in a dark pattern is displayed on panel 10, no sustain discharge occurs in a subfield having the largest luminance weight in some cases. It is experimentally verified that the number of lit discharge cells is greater in a subfield having a smaller luminance weight in a generally viewed moving image. For this reason, when a typical moving image is displayed on panel 10, the probability of occurrence of a sustain discharge in the subfield having the smallest luminance weight is higher than the probability of occurrence of a sustain discharge in the subfield having the largest luminance weight, although this phenomenon depends on the pattern of the image. That is, the probability of occurrence of a sustain discharge in the subfield having the largest luminance weight is lower than the probability of occurrence of a sustain discharge in the subfield having the smallest luminance weight.

Therefore, in a structure where the luminance weight of subfield SF1 is the largest and the luminance weight sequentially decreases toward the last subfield, the probability of occurrence of a sustain discharge in subfield SF1 is low. Thus, in some discharge cells, the address operation in the last subfield can be unstable.

Then, in the structure of this exemplary embodiment, subfield SF1 is a subfield having the smallest luminance weight, subfield SF2 is a subfield having the largest luminance weight, and subfield SF3 and thereafter have luminance weights sequentially decreasing.

This structure can make the number of discharge cells for undergoing a sustain discharge in subfield SF1 greater than that in a structure where the luminance weight sequentially decreases from subfield SF1 toward the last subfield.

When a sustain discharge occurs in subfield SF1, the sustain discharge can replenish the wall charge and priming particles in the discharge cells. Thus, the address operation in the last subfield can be more stabilized.

Subfield SF1 is an all-cell initializing subfield. Thus, in subfield SF1, while the priming generated in the all-cell initializing operation is remaining, an address discharge can be caused, thus allowing a stable address operation. Therefore, even in discharge cells to be lit only in the subfield having the smallest luminance weight, a stable address discharge can be caused.

Further, since a subfield having a large luminance weight can be generated at an earlier time of one field, the magnitude of the afterglow can be sequentially reduced in subfield SF3 and thereafter as shown in FIG. 6.

This structure can reduce the leak of the afterglow into the next field, i.e. crosstalk.

That is, in plasma display apparatus 40 of this exemplary embodiment, the address operation in the last subfield can be stabilized in addition to the above reduction of crosstalk.

Next, a description is provided for the opening/closing operations of the shutters of pair of shutter glasses 50.

As described above, in this exemplary embodiment, both of right eye shutter 52R and left eye shutter 52L are in a closed state in the initializing period (all-cell initializing period) of subfield SF1 of any of the fields for the right eye and the fields for the left eye. Thus, the light emission generated by the all-cell initializing operation is blocked by right eye shutter 52R and left eye shutter 52L and does not enter the eyes of the user. That is, the user who views a 3D image through pair of shutter glasses 50 does not perceive the light emission caused by the all-cell initializing operation. Therefore, the user can perceive black where the luminance caused by the light emission is reduced, and view an image of high contrast at reduced luminance of black level.

Further, since both of right eye shutter 52R and left eye shutter 52L are in a closed state, the afterglow during the period is blocked. Therefore, the shutter opening timing is set as late as possible in the following manner. The shutters of pair of shutter glasses 50 do not open until the afterglow of the display image has sufficiently attenuated (i.e. left eye shutter 52L does not open immediately after display of an image for the right eye, and right eye shutter 52R does not open immediately after display of an image for the left eye). This timing can lengthen the period during which the afterglow is blocked, and enhance the advantage of reducing the crosstalk.

In pair of shutter glasses 50, the time corresponding to the characteristics of the materials (e.g. liquid crystal) making up a shutter is taken after the shutter starts to close and before it completely closes, or after the shutter starts to open and before it completely opens. Pair of shutter glasses 50 takes approximately 0.5 msec, for example, to start to close and completely close (the transmittance of the shutter changing from 100% to 10%, for example). The pair of shutter glasses takes approximately 2 msec, for example, to start to open and completely open (the transmittance of the shutter changing from 0% to 90%, for example).

In this exemplary embodiment, with these facts taken into account, the opening/closing timings of right eye shutter 52R and left eye shutter 52L are set.

The shutter opening/closing timing signals are output from timing signal output part 46 to pair of shutter glasses 50 such that the shutters (left eye shutter 52L and right eye shutter 52R) have completely opened immediately before the sustain period of subfield SF2. This operation can prevent the entry of the afterglow in the preceding field into the eyes of the user without blocking the light emission in subfield SF2, and thereby reduce the crosstalk.

Then, in a field for the right eye (e.g. field F1), timing generation circuit 45 of this exemplary embodiment generates a shutter opening/closing timing signal (timing signal for opening/closing the right eye shutter) and outputs the timing signal from timing signal output part 46 to pair of shutter glasses 50 in the following manner. Right eye shutter 52R starts to open before the start of the sustain period of subfield SF1 and right eye shutter 52R has completely opened immediately before the start of the sustain period of subfield SF2. Further, right eye shutter 52R starts to close after the generation of the sustain pulses in the sustain period of subfield SF5, i.e. the last subfield, has been completed.

In a field for the left eye (e.g. field F2), the timing generation circuit generates a shutter opening/closing timing signal (timing signal for opening/closing the left eye shutter) and outputs the timing signal from timing signal output part 46 to pair of shutter glasses 50 in the following manner. Left eye shutter 52L starts to open before the start of the sustain period of subfield SF1 and left eye shutter 52L has completely opened immediately before the start of the sustain period of subfield SF2. Further, left eye shutter 52L starts to close after the generation of the sustain pulses in the sustain period of subfield SF5, i.e. the last subfield, has been completed.

The same operation is repeated in each field. This operation can reduce crosstalk and thus improve the image display quality. Thereby, an excellent stereoscopic view is achieved in plasma display apparatus 40.

However, when the opening or closing of the shutters of pair of shutter glasses 50 is controlled in this manner, in the sustain period of subfield SF1, the shutter corresponding to the image to be displayed in the field (left eye shutter 52L or right eye shutter 52R) is in the state of gradually opening, and the transmittance is lower than 100%.

In this case, the user perceives a light emission at a luminance reduced in response to the transmittance of pair of shutter glasses 50 in the sustain period of subfield SF1. For instance, when the average value of transmittances of pair of shutter glasses 50 in the sustain period of subfield SF1 is 50%, the user who views a 3D image through pair of shutter glasses 50 perceives the emission luminance in the sustain period of subfield SF1 50% lower than the original one.

When panel 10 is driven by a subfield method, gradations are displayed by the combination of subfields where light is emitted. Thus, when the emission luminance of the sustain discharge in subfield SF1 is reduced, the linearity of gradations can be impaired.

However, even if the shutter has not opened completely at the start of the sustain period of subfield SF1 and the average value of transmittances of pair of shutter glasses 50 in the sustain period of subfield SF1 is lower than 100%, increasing the number of sustain pulses in response to the average value of transmittances of pair of shutter glasses 50 enables the user to perceive that the luminance in subfield SF1 is not changed.

Therefore, in this exemplary embodiment, the number of sustain pulses generated in the sustain period of subfield SF1 is corrected based on the average value of transmittances of pair of shutter glasses 50 in the sustain period of subfield SF1. Specifically, the luminance weight of subfield SF1 is multiplied by a predetermined luminance magnification, and the multiplication result is further multiplied by a factor corresponding to the average value of transmittances of pair of shutter glasses 50 in the sustain period of subfield SF1.

The thus obtained number of sustain pulses are generated in the sustain period of subfield SF1. This factor can be set to the inverse number of the average value of transmittances of pair of shutter glasses 50 in the sustain period of subfield SF1, for example. The transmittance of pair of shutter glasses 50 represents an average value of transmittances of pair of shutter glasses 50 in the sustain period of subfield SF1.

For instance, suppose the luminance weight of subfield SF1 is “1”, the luminance magnification is “1”, and the original number of sustain pulses to be generated in the sustain period of subfield SF1 is “2”. When the average value of transmittances of pair of shutter glasses 50 in the sustain period of subfield SF1 is 50%, the number of sustain pulses to be generated in the sustain period of subfield SF1 is set to “4”, which is obtained by multiplying the original number “2” by “2”, i.e. the inverse number of 50% (0.5). Then, four sustain pulses are generated in the sustain period of subfield SF1, and two sustain pulse are applied to each scan electrode 22 and sustain electrode 23. Alternatively, when the average value of transmittances of pair of shutter glasses 50 in the sustain period of subfield SF1 is 25%, the number of sustain pulses to be generated is set to “8”, which is obtained by multiplying “2” by “4”, i.e. the inverse number of 25% (0.25). Then, eight sustain pulses are generated in the sustain period of subfield SF1, and four sustain pulses are applied to each scan electrode 22 and sustain electrode 23.

In this manner, the number of sustain pulses to be generated in the sustain period of subfield SF1 is increased in response to the average value of transmittances of pair of shutter glasses 50 in the sustain period of subfield SF1. Thus, even when the average value of transmittances of pair of shutter glasses 50 in the sustain period of subfield SF1 is lower than 100%, the user who views a 3D image through pair of shutter glasses 50 can perceive subfield SF1 at the original emission luminance, e.g. an emission luminance corresponding to luminance weight “1”.

This operation can eliminate the need for setting the shutter opening timing such that the transmittance at the start of the sustain period of subfield SF1 is 100%. For example, in order to reduce the crosstalk to the user who views a display image, the shutter opening timing of pair of shutter glasses 50 can be delayed.

The transmittance of pair of shutter glasses 50 is a transmittance of the shutter corresponding to the image displayed in the field (left eye shutter 52L for an image for the left eye, and right eye shutter 52R for an image for the right eye). The transmittance of the shutter in the sustain period is an average value of transmittances of the shutter in the sustain period.

In this exemplary embodiment, subfield SF1 is a subfield having the smallest luminance weight. Thus, when the number of sustain pulses is increased in response to the transmittance, the increase in the number of sustain pulses can be minimized.

As described above, in the structure of this exemplary embodiment, in the sustain period of a subfield occurring first (first subfield) in one field, sustain pulses equal in number to the luminance weight of the subfield multiplied by a luminance magnification and multiplied by a factor corresponding to the average value of transmittances of pair of shutter glasses 50 in the sustain period of the first subfield are applied to each scan electrode 22 and sustain electrode 23. This operation can maintain the linearity of the gradations in the display image to the user who views a 3D image displayed on panel 10 through pair of shutter glasses 50.

When the average value of transmittances of pair of shutter glasses 50 in the sustain period of subfield SF1 is measured in advance, the above factor can be preset based on the measurement result.

Alternatively, the structure of this exemplary embodiment can be applied to a plasma display apparatus capable of changing the shutter opening timing of pair of shutter glasses 50. For example, the plasma display apparatus is configured so as to estimate the amount of crosstalk and change the shutter opening timing based on the estimated result. That is, in the plasma display apparatus, when an increase in the amount of crosstalk is estimated, both of right eye shutter 52R and left eye shutter 52L are closed so as to lengthen the period during which the afterglow is blocked and enhance the advantage of reducing the crosstalk. The structure of this exemplary embodiment is applied to such a plasma display apparatus that has a lookup table. The lookup table includes the data on the results of measurement made in advance on temporal changes in the transmittance at the opening of the shutters of pair shutter glasses 50. Thus, even if the shutter opening timing of pair of shutter glasses 50 changes with the pattern of the display image and thus the transmittance in the sustain period of subfield SF1 of pair of shutter glasses 50 changes, the transmittance of pair of shutter glasses 50 in the sustain period of subfield SF1 can be estimated with the shutter opening timing and the data in the lookup table. Therefore, based on the estimated value, the above factor can be changed. As a result, the user who views a 3D image displayed on panel 10 through pair of shutter glasses 50 can perceive subfield SF1 at the original emission luminance, e.g. the emission luminance corresponding to luminance weight “1”.

Alternatively, a plasma display apparatus may be configured such that a plurality of factors (e.g. integers 1 through 10) is prepared in advance and any one among the above factors can be chosen by the user. For such a plasma display apparatus, when the shutter opening characteristic is changed by the replacement of pair of shutter glasses 50, for example, the user can reset the factor by choosing the factor.

As described above, in the structure of this exemplary embodiment, in one field, the first subfield is a subfield having the smallest luminance weight, the succeeding subfield is a subfield having the largest luminance weight, and the subfields thereafter have the luminance weights sequentially decreasing. This structure can suppress crosstalk by reducing the afterglow leaking from one field into the next field, and stabilize the address operation in the last subfield.

In the structure of this exemplary embodiment, the number of sustain pulses to be generated in the sustain period of the first subfield is increased in response to the transmittance of pair of shutter glasses 50. With this structure, the user who views a 3D image through pair of shutter glasses 50 can perceive subfield SF1 at the original emission luminance, e.g. the emission luminance corresponding to luminance weight “1”.

That is, this exemplary embodiment can provide an image where the contrast is enhanced by reducing the luminance of black level and the crosstalk is reduced, and precisely display gradations on panel 10 by maintaining the linearity of the gradations in the display image to the user who views a 3D image displayed on panel 10 through pair of shutter glasses 50. Thus, the image display quality can be enhanced.

The above description of “the shutter completely closes” means that the transmittance of the shutter becomes equal to or lower than 10%. The above description of “the shutter completely opens” means that the transmittance of the shutter becomes equal to or higher than 90%.

In the example of the structure described in this exemplary embodiment, each of the field for the right eye and the field for the left eye is formed of five subfields. However, the number of subfields in the present invention is not limited to the above numerical values. If the number of subfields is increased to six or greater, for example, the number of gradations displayable on panel 10 can be further increased. The number of subfields forming each field can be set optimally for the specifications of plasma display apparatus 40, for example.

In the example described in this exemplary embodiment, the luminance weights of the subfields are powers of “2” and the luminance weights of the respective subfields are set to 1, 16, 8, 4, and 2. However, the luminance weights in the present invention are not limited to the above numerical values. Setting the luminance weights of respective subfields to 1, 12, 7, 3, and 2, for example, gives redundancy to the combination of the subfields determining gradations and allows the coding for suppressing the generation of the moving image false contour.

The driving voltage waveforms in FIG. 4 only show an example in the exemplary embodiment of the present invention. The present invention is not limited to these driving voltage waveforms.

Each circuit block shown in the exemplary embodiment of the present invention may be formed as an electric circuit that performs each operation shown in the exemplary embodiment, or formed of a microcomputer programmed so as to perform the similar operations, for example.

In the example described in this exemplary embodiment, one pixel is formed of discharge cells of R, G, and B three colors. Also a panel that includes pixels, each formed of discharge cells of four or more colors, can use the structure shown in this exemplary embodiment and provide the same advantages.

The specific numerical values shown in the exemplary embodiment of the present invention are set based on the characteristics of panel 10 that has a 50-inch screen and 1080 display electrode pairs 24, and simply show examples in the exemplary embodiment. The present invention is not limited to these numerical values. Preferably, each numerical value is set optimally for the characteristics of the panel, the specification of the plasma display apparatus, or the like. Variations are allowed for each numerical value within the range in which the above advantages can be obtained. Further, the number of subfields, the luminance weights of the respective subfields, or the like is not limited to the values shown in the exemplary embodiment of the present invention. The subfield structure may be switched based on image signals, for example.

### INDUSTRIAL APPLICABILITY

The present invention can reduce crosstalk and maintain the linearity of gradations in a display image, and thereby enhance the image display quality to the user who views the display image through a pair of shutter glasses in a plasma display apparatus usable as a 3D image display apparatus. Thus, the present invention is useful as a plasma display apparatus, a plasma display system, and a driving method for a panel.

### REFERENCE MARKS IN THE DRAWINGS

10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
40 Plasma display apparatus
41 Image signal processing circuit
42 Data electrode driver circuit
43 Scan electrode driver circuit
44 Sustain electrode driver circuit
45 Timing generation circuit
46 Timing signal output part
50 Pair of shutter glasses
52R Right eye shutter
52L Left eye shutter

1. A plasma display apparatus comprising:
a plasma display panel having a plurality of discharge cells, each of the discharge cells having a display electrode pair formed of a scan electrode and a sustain electrode;
a driver circuit for displaying an image on the plasma display panel by alternately repeating a field for a right eye where the plasma display panel is driven based on an image signal for the right eye and a field for a left eye where the plasma display panel is driven based on an image signal for the left eye, and for driving the plasma display panel in a manner such that each of the field for the right eye and the field for the left eye is formed of a plurality of subfields, each of which has a sustain period where sustain pulses corresponding in number to a luminance weight are generated; and
a timing generation circuit for generating a timing signal for controlling the driver circuit, and generating shutter opening/closing timing signals that include a timing signal for opening/closing a right eye shutter and a timing signal for opening/closing a left eye shutter, the timing signal for opening/closing the right eye shutter being set to ON when the field for the right eye is displayed on the plasma display panel and to OFF when the field for the left eye is displayed on the plasma display panel, the timing signal for opening/closing the left eye shutter being set to ON when the field for the left eye is displayed on the plasma display panel and to OFF when the field for the right eye is displayed on the plasma display panel,
wherein, in the sustain periods of the subfields except a first subfield of one field, the driver circuit applies the sustain pulses equal in number to the luminance weight multiplied by a predetermined luminance magnification to each scan electrode and each sustain electrode, and
in the sustain period of the first subfield, the driver circuit applies the sustain pulses greater in number than the luminance weight multiplied by the predetermined luminance magnification to each scan electrode and each sustain electrode.

2. The plasma display apparatus of claim 1, wherein the driver circuit generates a subfield having a smallest luminance weight first, a subfield having a largest luminance weight next, and other subfields thereafter, in each of the field for the right eye and the field for the left eye.

3. A plasma display system comprising:
a plasma display apparatus including:
a plasma display panel having a plurality of discharge cells, each of the discharge cells having a display electrode pair formed of a scan electrode and a sustain electrode;
a driver circuit for displaying an image on the plasma display panel by alternately repeating a field for a right eye where the plasma display panel is driven based on an image signal for the right eye and a field for a left eye where the plasma display panel is driven based on an image signal for the left eye, and for driving the plasma display panel in a manner such that each of the field for the right eye and the field for the left eye is formed of a plurality of subfields, each of which has a sustain period where sustain pulses corresponding in number to a luminance weight are generated; and
a timing generation circuit for generating a timing signal for controlling the driver circuit, and generating shutter opening/closing timing signals that include a timing signal for opening/closing a right eye shutter and a timing signal for opening/closing a left eye shutter, the timing signal for opening/closing the right eye shutter being set to ON when the field for the right eye is displayed on the plasma display panel and to OFF when the field for the left eye is displayed on the plasma display panel, the timing signal for opening/closing the left eye shutter being set to ON when the field for the left eye is displayed on the plasma display panel and to OFF when the field for the right eye is displayed on the plasma display panel; and
a pair of shutter glasses controlled by the shutter opening/closing timing signals generated in the timing generation circuit, the pair of shutter glasses having a right eye shutter and a left eye shutter, the right eye shutter transmitting visible light when the timing signal for opening/closing the right eye shutter is set to ON and blocking visible light when the timing signal for opening/closing the right eye shutter is set to OFF, the left eye shutter transmitting visible light when the timing signal for opening/closing the left eye shutter is set to ON and blocking visible light when the timing signal for opening/closing the left eye shutter is set to OFF,
wherein, in the sustain periods of the subfields except a first subfield of one field, the driver circuit applies the sustain pulses equal in number to the luminance weight multiplied by a predetermined luminance magnification to each scan electrode and each sustain electrode, and
in the sustain period of the first subfield, the driver circuit applies, to each scan electrode and each sustain electrode, the sustain pulses corresponding in number to the luminance weight multiplied by the predetermined luminance magnification and multiplied by a factor corresponding to a transmittance of the pair of shutter glasses in the sustain period of the first subfield.

4. The plasma display system of claim 3, wherein the driver circuit generates a subfield having a smallest luminance weight first, a subfield having a largest luminance weight next, and other subfields thereafter, in each of the field for the right eye and the field for the left eye.

5. A driving method for a plasma display panel,
the plasma display panel having a plurality of discharge cells, each of the discharge cells having a display electrode pair formed of a scan electrode and a sustain electrode,
the driving method comprising:
displaying an image on the plasma display panel by alternately repeating a field for a right eye where the plasma display panel is driven based on an image signal for the right eye and a field for a left eye where the plasma display panel is driven based on an image signal for the left eye;
driving the plasma display panel in a manner such that each of the field for the right eye and the field for the left eye is formed of a plurality of subfields, each of the subfields having a sustain period where sustain pulses corresponding in number to a luminance weight are generated; and
generating shutter opening/closing timing signals that include a timing signal for opening/closing a right eye shutter and a timing signal for opening/closing a left eye shutter, the timing signal for opening/closing the right eye shutter being set to ON when the field for the right eye is displayed on the plasma display panel and to OFF when the field for the left eye is displayed on the plasma display panel, the timing signal for opening/closing the left eye shutter being set to ON when the field for the left eye is displayed on the plasma display panel and to OFF when the field for the right eye is displayed on the plasma display panel,
wherein, in the sustain periods of the subfields except a first subfield of one field, the sustain pulses equal in number to the luminance weight multiplied by a predetermined luminance magnification are applied to each scan electrode and each sustain electrode, and
in the sustain period of the first subfield, the sustain pulses greater in number than the luminance weight multiplied by the predetermined luminance magnification are applied to each scan electrode and each sustain electrode.

6. The driving method for the plasma display panel of claim 5, wherein a subfield having a smallest luminance weight is generated first, a subfield having a largest luminance weight is generated next, and other subfields are generated thereafter, in each of the field for the right eye and the field for the left eye.
